(19) United States
(12) Patent Application Publication
(10) Pub. No.: US 2016/0178927 A1
(43) Pub. Date: Jun. 23, 2016

(54) EYEGLASS ASSEMBLY

(71) Applicant: ALL-LOGIC INT. CO., LTD., Tainan City (TW)

(72) Inventor: Shun-Tien YANG, Tainan City (TW)

(21) Appl. No.: 14/844,686

(22) Filed: Sep. 3, 2015

(30) Foreign Application Priority Data
Dec. 23, 2014 (TW) 103222725

(51) Int. Cl. G02C 1/04; G02C 5/10; G02C 5/12; G02C 5/00

(52) U.S. Cl. CPC G02C 1/04; G02C 5/008; G02C 5/10; G02C 5/126; G02C 2200/08

(57) ABSTRACT

An eyeglass assembly includes a lens unit and a pair of side frame units. The lens unit includes a pair of interconnected lenses. Each side frame unit is detachably coupled to a respective one of the lenses and has a lens-holding segment, a pad arm segment that extends from the lens-holding segment and that removably engages the respective lens, and a temple arm pivoted to the lens-holding segment. The pad arm segment of each side frame unit is deformable between a non-deformed state for engaging the respective lens, and a deformed state for allowing removal of the corresponding side frame unit from the respective lens.

### CROSS-REFERENCE TO RELATED APPLICATION

This application claims priority of Taiwanese Utility Model Application No. 103222725, filed on Dec. 23, 2014.

### FIELD

The disclosure relates to an eyeglass assembly, more particularly to an eyeglass assembly which is easy to assemble/disassemble.

### BACKGROUND

As illustrated in FIG. 1, Taiwanese Utility Model No. M395839 discloses a conventional eyeglass assembly 1, which includes a top frame 11 and a pair of bottom frame segments 12 that are removably coupled to the top frame 11 to respectively engage a pair of lenses 13. Although the configuration of the bottom frame segments 12 may reduce the weight of the conventional eyeglass assembly 1, the bottom frame segments 12 are necessary for retaining the lenses 13. Moreover, when disassembling the conventional eyeglass assembly 1, the bottom frame segments 12 are required to be detached from the top frame 11 before the lenses 13 maybe removed. Such disassembling process is inconvenient and time-consuming.

### SUMMARY

Therefore, an object of the disclosure is to provide an eyeglass assembly that can alleviate at least one of the abovementioned drawbacks associated with the prior art.

According to the disclosure, an eyeglass assembly may include a lens unit and a pair of side frame units.

The lens unit includes a pair of interconnected lenses.

Each of the side frame units is detachably coupled to a respective one of the lenses and has a lens-holding segment, a pad arm segment that extends from the lens-holding segment, that is made of a resiliently deformable material and that removably engages the respective one of the lenses, and a temple arm that is pivotally connected to the lens-holding segment opposite to the pad arm segment.

The pad arm segment of each of the side frame units is deformable between a non-deformed state for engaging the respective one of the lenses, and a deformed state for allowing the respective one of the lenses to be disengaged from the pad arm segment so as to enable removal of the corresponding side frame unit from the respective one of the lenses.

### BRIEF DESCRIPTION OF THE DRAWINGS

Other features and advantages of the disclosure will become apparent in the following detailed description of the exemplary embodiment with reference to the accompanying drawings, of which:

FIG. 1 is an exploded perspective view of a conventional eyeglass assembly;

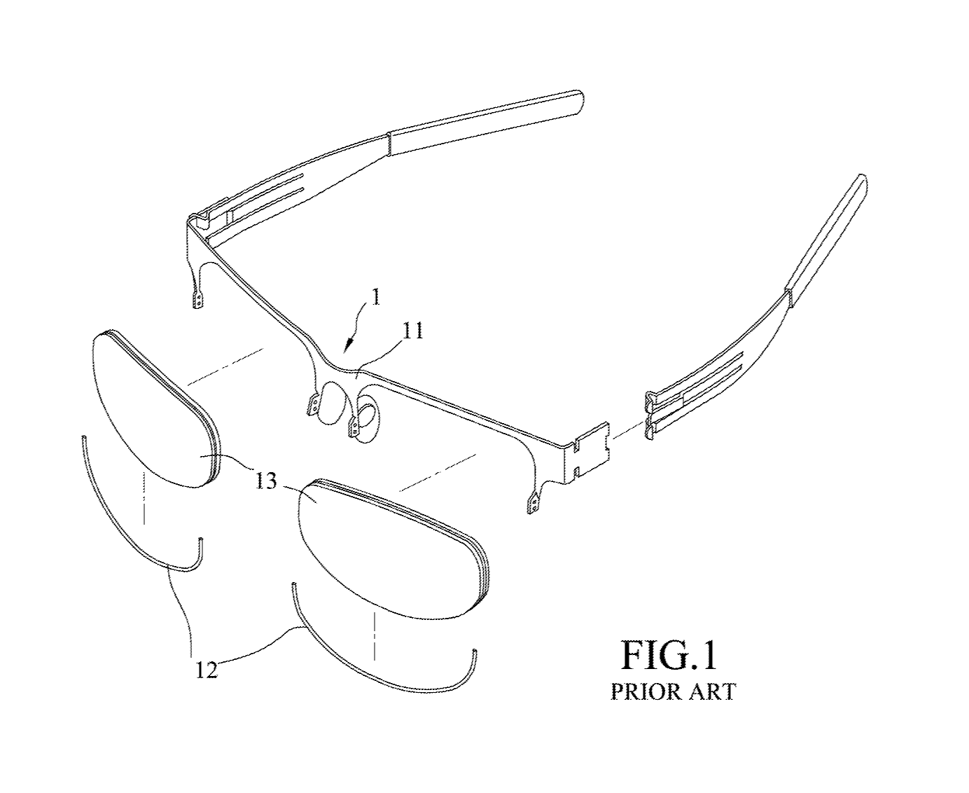

FIG. 2 is an exploded perspective view of the exemplary embodiment of an eyeglass assembly according to the present disclosure;

FIG. 3 is a fragmentary front view of the exemplary embodiment;

FIG. 4 is an exploded fragmentary perspective view of the exemplary embodiment, illustrating pad arm segments and nose pads of the eyeglass assembly;

FIG. 5 is a rear perspective view of the exemplary embodiment, illustrating that the pad arm segments are at a non-deformed state and that side frame units engage a lens unit;

FIG. 6 is a rear perspective view of the exemplary embodiment, illustrating that one of the side frame units is partly detached from the lens unit; and

FIG. 7 is a rear perspective view of the exemplary embodiment, illustrating that one of the side frame units is completely detached from the lens unit.

### DETAILED DESCRIPTION

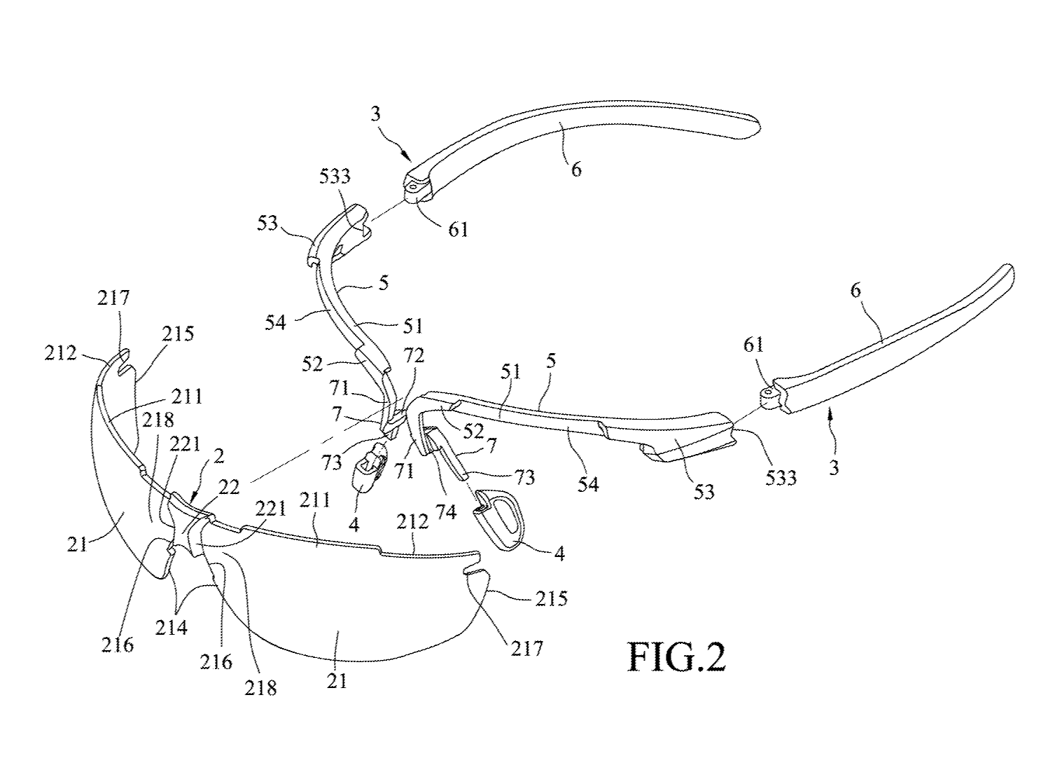

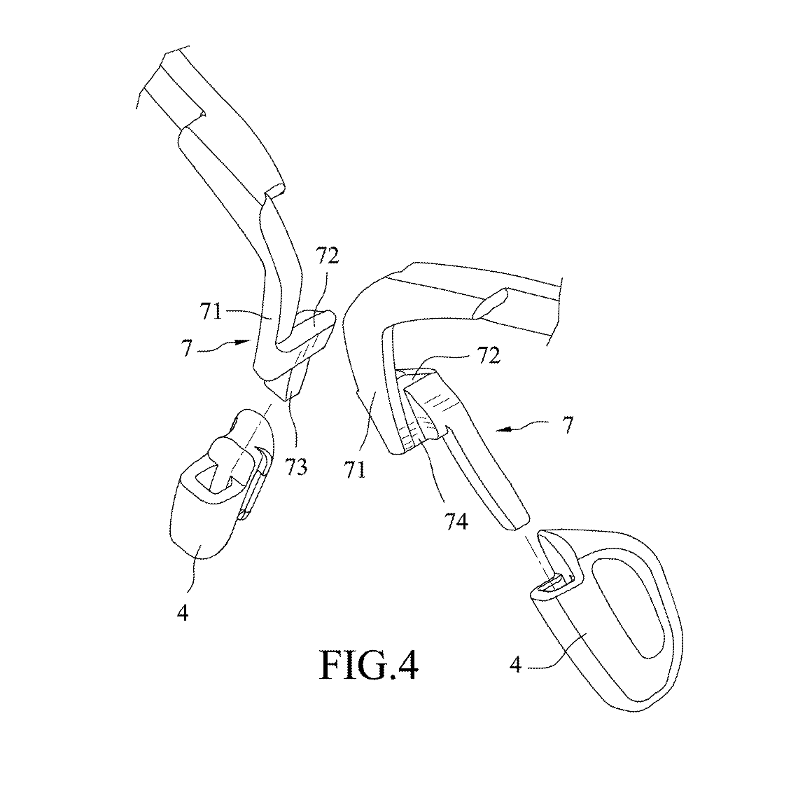

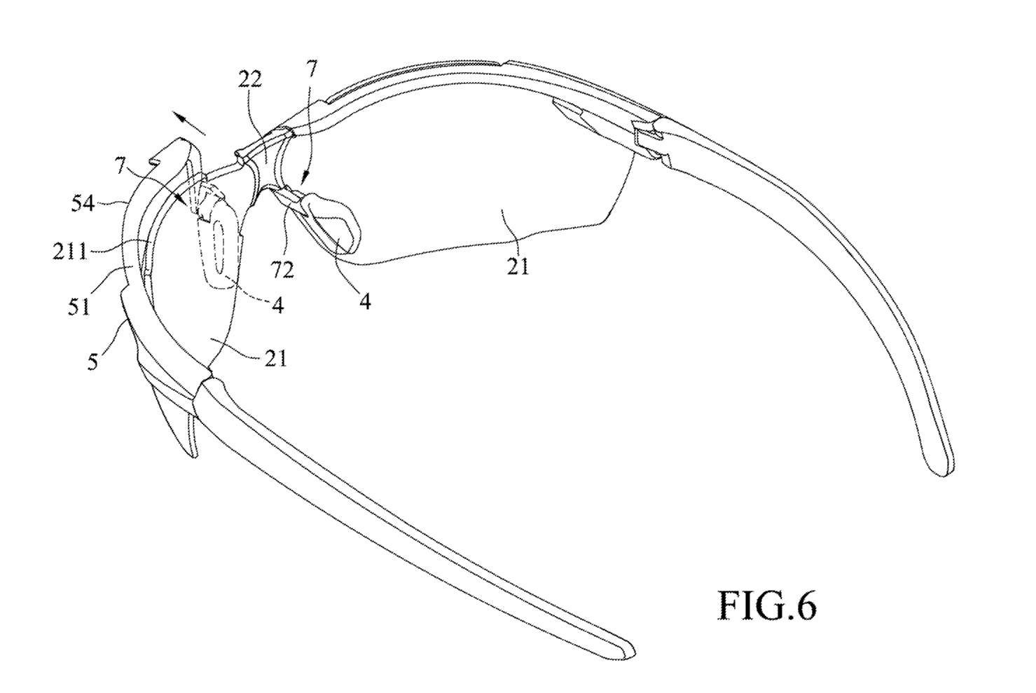

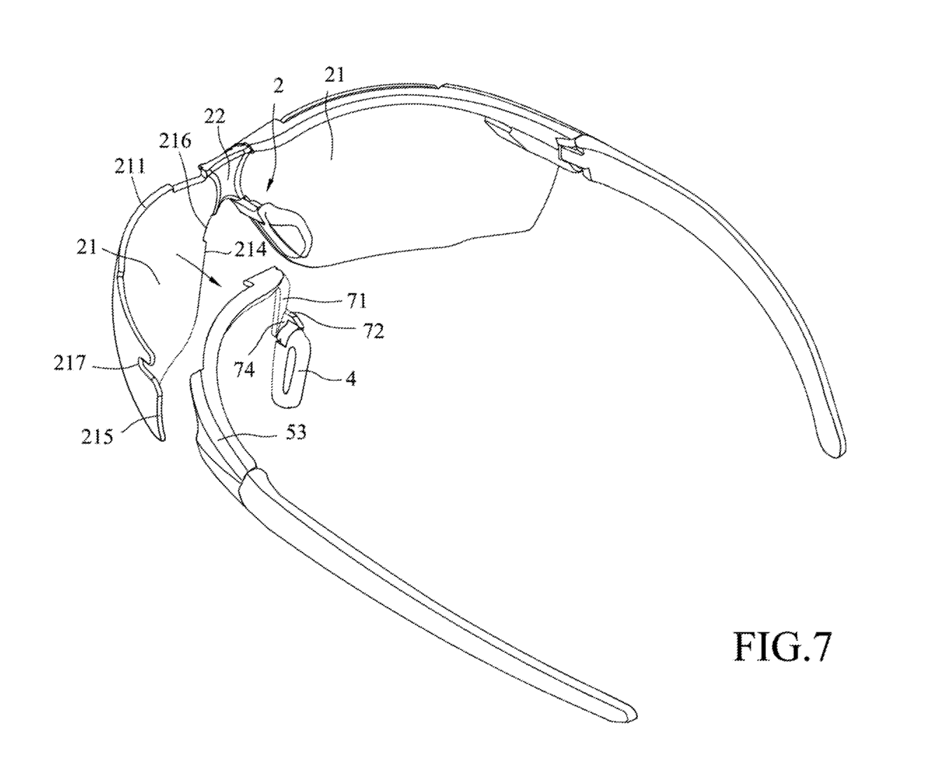

Referring to FIGS. 2 to 7, the exemplary embodiment of an eyeglass assembly according to the present disclosure is shown to include a lens unit 2 and a pair of side frame units 3.

The lens unit 2 includes a pair of interconnected lenses 21 each having an inner side portion 218 adjacent to the other one of the lenses 21. In this embodiment, the lens unit 2 further includes a bridge component 22 which interconnects the lenses 21 at the inner side portions 218 and has a pair of opposite side portions 221 that are symmetrically shaped.

As shown in FIG. 2, the side frame units 3 of this embodiment are separate from each other. Each side frame unit 3 is detachably coupled to a respective one of the lenses 21 and has a lens-holding segment 5, a pad arm segment 7 that extends from the lens-holding segment 5, that is made of a resiliently deformable material and that removably engages the respective one of the lenses 21, and a temple arm 6 that is pivotally connected to the lens-holding segment 7 opposite to the pad arm segment 5.

Each lens-holding segment 5 extends in a left-to-right direction and is detachably coupled to a top side portion of the respective one of the lenses 21. To be specific, the top side portion of each of the lenses 21 has a top edge 212 provided with a positioning part 211, and the lens-holding segment 5 of each side frame unit 3 is formed with a first positioning groove 54 to detachably couple to the positioning part 211 of the respective one of the lenses 21. In this embodiment, the first positioning groove 54 is an indentation in a front surface of the lens-holding segment 5 and extends from a top edge to a bottom edge of the lens-holding segment 5.

As illustrated in FIG. 2, each lens-holding segment 5 has a central portion 51 that extends along the left-to-right direction, a first connecting portion 52 that interconnects the central portion 51 and the corresponding pad arm segment 7, and a second connecting portion 53 that interconnects the central portion 51 and the respective temple arm 6. The central portion 51, and the first and second connecting portions 52, 53 cooperatively define the first positioning groove 54.

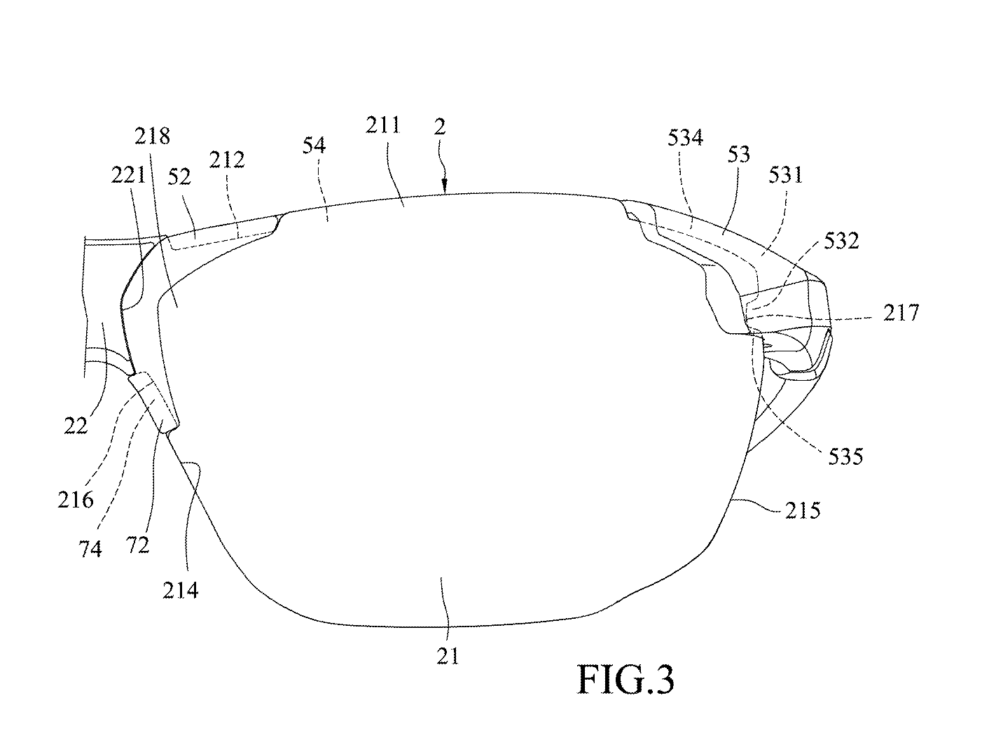

It is worth noting that, in this embodiment, the second connecting portion 53 of the lens-holding segment 5 of each side frame unit 3 is formed with a second positioning groove 531 (see FIG. 3) to removably engage an outer side portion of the respective one of the lenses 21. In addition, as illustrated in FIGS. 2 and 3, the outer side portion of each of the lenses 21 has an outer edge 215 that may be formed with a positioning notch 217, and the second connecting portion 53 of the lens-holding segment 5 of each side frame unit 3 may have a positioning protrusion 532 formed in the second positioning groove 531 for removably engaging the positioning notch 217 of the respective one of the lenses 21, so as to enhance the coupling strength between each lens-holding segment 5 and the respective lens 21. The positioning protrusion 532 may divide the second positioning groove 531 into an upper first groove section 534 and a lower second groove section 535 which is shorter than the first groove section 534.

In this embodiment, as shown in FIG. 2, the second connecting portion 53 of the lens-holding segment 5 of each side frame unit 3 has a distal end that is distal from the central portion 51 of the lens-holding segment 5 and that is formed with a coupling recess 533, and the temple arm 6 of each side frame unit 3 has a front end portion having a pivot segment 61 that is pivotally and detachably coupled to the second connecting portion 53 of the lens-holding segment 5 at the coupling recess 533.

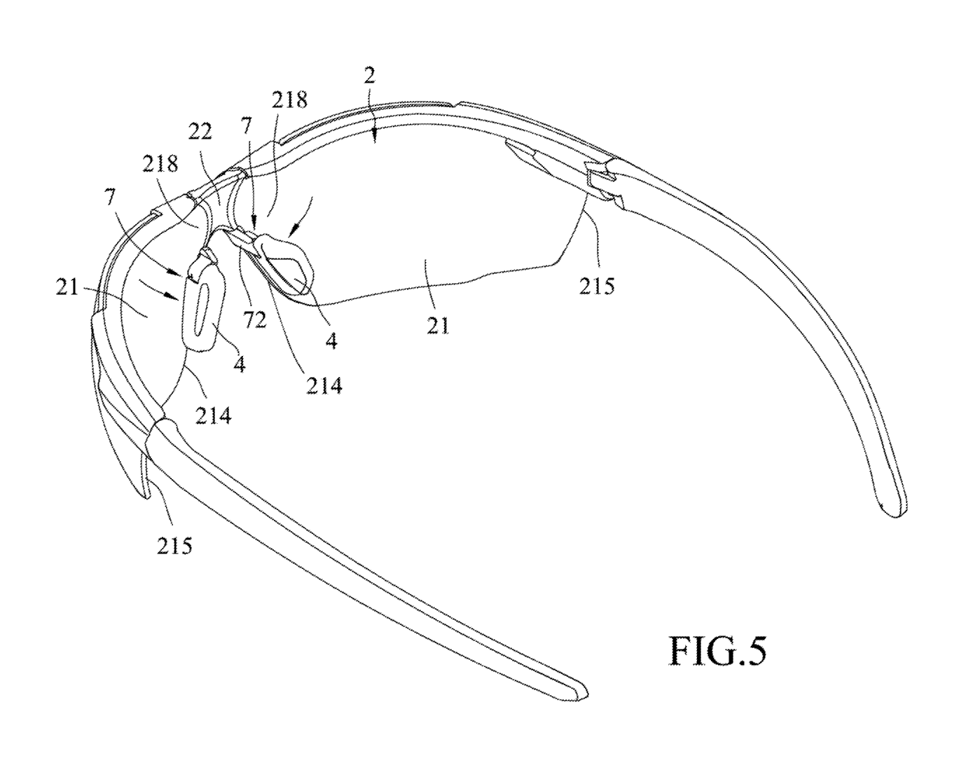

As shown in FIGS. 2 to 4, each pad arm segment 7 of this embodiment has a hanging portion 71, a rearward-extending portion 72 and a pad-mounting portion 73. The hanging portion 71 extends downwardly from the first connecting portion 51 of the lens-holding segment 5 of the corresponding side frame unit 3 and is to be disposed on a front surface of the respective one of the lenses 21 at the inner side portion 218 of the respective one of the lenses 21 (see FIG. 3). It should be noted that, the hanging portion 71 of each pad arm segment 7 may be disposed adjacent to a respective side portion 221 of the bridge component 22 and may be complementary in shape to the respective side portion 221 as illustrated in FIG. 3. The rearward-extending portion 72 is connected to and extends rearwardly from the hanging portion 71, and is vertically spaced apart from the lens-holding segment 5. With further reference to FIG. 5, the rearward-extending portion 72 is to be disposed adjacent to the inner side portion 218 of the respective one of the lenses 21 in a manner that the rearward-extending portion 72 extends in a front-to-rear direction relative to the inner side portion 218 of the respective one of the lenses 21. The pad-mounting portion 73 is connected to and extends downwardly from the rearward-extending portion 72. The pad-mounting portion 73 is to be disposed on a rear surface of the respective one of the lenses 21 at the inner side portion 218 of the respective lens 21. The hanging portion 71, the rearward-extending portion 72 and the pad-mounting portion 73 of the pad-mounting segment 7 of each side frame unit 3 cooperatively define a retaining space 74 for engaging the inner side portion 218 of the respective one of the lenses 21. As illustrated in FIGS. 2 and 3, the inner side portion 218 of each of the lenses 21 has an inner edge 214 that is formed with a coupling notch 216 to removably couple with the rearward-extending portion 72 of the pad arm segment 7 of the respective side frame unit 3.

In this embodiment, the eyeglass assembly may further include a pair of nose pads 4 each removably mounted to the pad-mounting portion 73 of the pad arm segment 7 of a respective one of the side frame units 3, as shown in FIGS. 2 to 4.

As illustrated in FIGS. 5 to 7, the pad arm segment 7 of each of the side frame units 3 is deformable between a non-deformed state (see FIG. 5) for engaging the respective one of the lenses 21, and a deformed state for allowing the respective one of the lenses 21 to be disengaged from the pad arm segment 7, so as to enable removal of the corresponding side frame unit 3 from the respective one of the lenses 21.

In greater detail, as illustrated in FIG. 5, when the pad arm segment 7 is at the non-deformed state and when the lenses 21 respectively engage the side frame units 3, the hanging portion 71 is disposed on the front surface of the respective one of the lenses 21, the rearward-extending portion 72 is disposed adjacent to the inner side portion 218 of the respective one of the lenses 21 and is coupled to the coupling notch 216 of the respective one of the lenses 21, the pad-mounting portion 73 is disposed on the rear surface of the respective one of the lenses 21, and the inner side portion 218 of the respective one of the lenses 21 is retained in the retaining space 74. At the same time, with reference to FIG. 3, the first positioning groove 54 of the lens-holding segment 5 is coupled to the positioning part 211 of the respective one of the lenses 21, the second engaging groove 531 of the lens-holding segment 5 engages the outer side portion of the respective one of the lenses 21, and the positioning protrusion 532 of the lens holding segment 5 engages the positioning notch 217 of the respective one of the lenses 21.

When the lenses 21 of the lens unit 2 need to be replaced or repaired, the pad-arm segment 7 can be deformed from the non-deformed state to the deformed state first, allowing the hanging portion 71, the rearward-extending portion 72 and the pad-mounting portion 73 of the pad arm segment 7 to be moved away from the temple arm 6 of the corresponding side frame unit 3 and inwardly toward the bridge component 22, so as to detach the rearward-extending portion 72 from the coupling notch 216 of the respective one of the lenses 21 and to release the respective one of the lenses 21 from the retaining space 74. Then, the pad arm segment 7 may be pushed forwardly to be away from the respective one of the lenses 21 and in front of the lens unit 2, and may be further pushed forwardly and upwardly relative to the lens unit 2 to enable the positioning part 211 of the respective one of the lenses 21 to be detached from the first positioning groove 54, the outer side portion of the respective lens 21 to be disengaged from the second engaging groove 531 of the lens-holding segment 53, and the positioning notch 217 of the respective lens 21 to be disengaged from the positioning protrusion 532 of the lens-holding segment 53. In such a manner, both lenses 21 of the lens unit 2 can be completely and respectively detached from the side frame units 3.

On the other hand, when a user wishes to assemble the eyeglass assembly of the exemplary embodiment, the positioning notch 217 and the outer side portion of each of the lenses 21 may be first respectively engaged with the second engaging groove 531 and the positioning protrusion 532 of the lens-holding segment 5 of the respective side frame unit 3, followed by coupling the positioning part 211 of the respective one of the lenses 21 with the first positioning groove 54. Then, the pad arm segment 7 may be pushed rearwardly to abut against the inner side portion 218 of the respective one of the lenses 21. The abutment may generate a force to cause the pad arm segment 7 to deform to the deformed state and enables the rearward-extending portion 72 and the pad-mounting portion 73 of the pad arm segment 7 to pass through a space which is below the bridge component 22 and between the lenses 21. Once the rearward-extending portion 72 and the pad-mounting portion 73 reach a predetermined position, the pad arm segment 7 may automatically return to the non-deformed state due to its resilient property, enabling the inner side portion 218 of the respective one of the lenses 21 to be retained in the retaining space 74, and the rearward-extending portion 72 to couple with the coupling notch 216. In such a manner, the side frame unit 3 is once again coupled to the respective one of the lenses 21.

By utilizing the lens holding segment 5 and the pad arm segment 7 of each side frame unit 3 to couple to the respective one of the lenses 21 at two opposite sides thereof, the coupling strengths between the side frame units 3 and the lens unit 2 are greatly enhanced, so that bottom frame segments can be omitted for further weight reduction. Moreover, the assembling/disassembling process of the eyeglass assembly of the present disclosure is relatively simple and convenient owing to the pad arm segments 7 which are deformable between the non-deformed and deformed states to enable the side frame units 3 to be easily attached to (or detached from) the lens unit 2.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An eyeglass assembly, comprising:
a lens unit including a pair of interconnected lenses; and
a pair of side frame units each of which is detachably coupled to a respective one of said lenses and has a lens-holding segment, a pad arm segment that extends from said lens-holding segment, that is made of a resiliently deformable material and that removably engages the respective one of said lenses, and a temple arm that is pivotally connected to said lens-holding segment opposite to said pad arm segment;
wherein said pad arm segment of each of said side frame units is deformable between a non-deformed state for engaging the respective one of said lenses, and a deformed state for allowing the respective one of said lenses to be disengaged from said pad arm segment so as to enable removal of said corresponding side frame unit from the respective one of said lenses.

2. The eyeglass assembly according to claim 1, wherein:
each of said lenses has an inner side portion adjacent to the other one of said lenses;
said lens-holding segment of each of said side frame units extends in a left-to-right direction;
said pad arm segment of each of said side frame units has
a hanging portion that extends downwardly from said lens-holding segment of said corresponding side frame unit and that is to be disposed on a front surface of the respective one of said lenses at said inner side portion of the respective one of said lenses,
a rearward-extending portion that is connected to and extends rearwardly from said hanging portion, that is vertically spaced apart from said lens-holding segment, and that is to be disposed adjacent to said inner side portion of the respective one of said lenses in a manner that said rearward-extending portion extends in a front-to-rear direction relative to said inner side portion of the respective one of said lenses, and
a pad-mounting portion that is connected to and extends downwardly from said rearward-extending portion and that is to be disposed on a rear surface of the respective one of said lenses at said inner side portion of the respective one of said lenses; and
said hanging portion, said rearward-extending portion and said pad-mounting portion of said pad arm segment of each of said side frame units cooperatively define a retaining space for engaging said inner side portion of the respective one of said lenses when said pad arm segment is at the non-deformed state.

3. The eyeglass assembly according to claim 2, wherein said inner side portion of each of said lenses has an inner edge that is formed with a coupling notch to removably couple with said rearward-extending portion of said pad arm segment of said respective side frame unit.

4. The eyeglass assembly according to claim 1, wherein said lens-holding segment of each of said side frame units is detachably coupled to a top side portion of the respective one of said lenses.

5. The eyeglass assembly according to claim 4, wherein said top side portion of each of said lenses has a top edge provided with a positioning part, and said lens-holding segment of each of said side frame units is formed with a first positioning groove to detachably couple to said positioning part of the respective one of said lenses.

6. The eyeglass assembly according to claim 5, wherein said first positioning groove is an indentation in a front surface of said lens-holding segment and extends from a top edge to a bottom edge of said lens-holding segment.

7. eyeglass assembly according to claim 5, wherein:
said lens-holding segment of each of said side frame units has a central portion that extends in a left-to-right direction, a first connecting portion that interconnects said central portion and said pad arm segment, and a second connecting portion that interconnects said central portion and said temple arm; and
said central portion and said first and second connecting portions of said lens-holding segment cooperatively define said first positioning groove.

8. The eyeglass assembly according to claim 7, wherein said second connecting portion of said lens-holding segment of each of said side frame units is formed with a second positioning groove to removably engage an outer side portion of the respective one of said lenses.

9. The eyeglass assembly according to claim 8, wherein:
said outer side portion of each of said lenses has an outer edge that is formed with a positioning notch; and
said second connecting portion of said lens-holding segment of each of said side frame units has a positioning protrusion that is formed in said second positioning groove and that is for removably engaging said positioning notch of the respective one of said lenses.

10. The eyeglass assembly according to claim 7, wherein:
said second connecting portion of said lens-holding segment of each of said side frame units has a distal end that is distal from said central portion of said lens-holding segment and that is formed with a coupling recess; and
said temple arm of each of said side frame units has a front end portion having a pivot segment that is pivotally and detachably coupled to said second connecting portion of said lens-holding segment at said coupling recess.

11. The eyeglass assembly according to claim 2, further comprising a pair of nose pads each removably mounted to said pad-mounting portion of said pad arm segment of a respective one of said side frame units.

12. The eyeglass assembly according to claim 2, wherein said side frame units are separate from each other.

13. The eyeglass assembly according to claim 12, wherein said lens unit further includes a bridge component interconnecting said lenses and to be disposed between said hanging portions of said pad arm segments of said side frame units.

14. The eyeglass assembly according to claim 2, wherein, when said pad arm segment is deformed from the non-deformed state to the deformed state, said hanging portion, said rearward-extending portion and said pad-mounting portion of said pad arm segment are moved away from said temple arm of said corresponding side frame unit for releasing the respective one of said lenses from said retaining space.
